(19) United States
(12) Patent Application Publication
(10) Pub. No.: US 2026/0100290 A1
(43) Pub. Date: Apr. 9, 2026

(54) MAGNETIC MIRROR DIPOLE FIELD FUSION DEVICE

(71) Applicants: EAST CHINA UNIVERSITY OF TECHNOLOGY, Nanchang (CN); JIANGXI LIZHEN ISOTOPE TECHNOLOGY Co., LTD, Nanchang (CN)

(72) Inventors: Jinhai LI, Nanchang (CN); Guoshu ZHANG, Nanchang (CN); Bin TANG, Nanchang (CN)

(21) Appl. No.: 18/922,259

(22) Filed: Oct. 21, 2024

(30) Foreign Application Priority Data
Sep. 11, 2021 (CN) 202411274183.6
Sep. 11, 2024 (CN) 202411273874.4

(51) Int. Cl. G21B 1/05; G21B 1/17

(52) U.S. Cl. CPC G21B 1/05; G21B 1/17

(57) ABSTRACT

A magnetic mirror dipole field fusion device comprises an excitation ring and two magnetic compression superconductors; and the magnetic compression superconductors are arranged at north and south poles of a dipole field, and a rotating shaft of the magnetic compression superconductor is coaxial with the excitation ring. A cross section of an excitation ring made of a normal temperature material is a circle or a square, and an excitation ring made of a superconducting material is a cylinder. A gap between the excitation ring and the magnetic compression superconductor is a magnetic mirror region, and a region outside the excitation ring is a fusion region. The magnetic mirror region has a very high magnetic field, and can reflect high-energy helium ions generated by fusion. The dipole field adopting a superconducting magnetic field compressor can cancel a levitated coil, and reduce a development difficulty and construction and operation costs.

### CROSS-REFERENCE TO RELATED APPLICATIONS

This application claims the foreign priority of Chinese Patent Application No. 202411273874.4, filed on Sep. 11, 2024, in the China National Intellectual Property Administration, and Chinese Patent Application No. 202411274183.6, filed on Sep. 11, 2024, in the China National Intellectual Property Administration. The contents of the aforementioned applications, including any intervening amendments thereto, are incorporated herein by reference.

### TECHNICAL FIELD

The present invention relates to the field of nuclear fusion, and particularly to a dipole field fusion device.

### BACKGROUND OF THE PRESENT INVENTION

Dipole field fusion device is a device which uses a dipole field formed by a single coil to confine plasma to realize fusion, as shown in FIG. 1. The dipole field fusion device has the advantages of high plasma specific pressure, no plasma disruption, natural in-pinch, natural stability, external fusion of magnet, no tritium self-sustaining problem, large vacuum chamber space, simple structure, low cost, and the like.

The dipole field fusion device also has some shortcomings. Firstly, because the magnetic field is distributed to the whole space, a plasma aggregation region has a very low magnetic field intensity, so that the confined plasma have low density and temperature. However, nuclear fusion requires very high plasma density and temperature, so that it is necessary to greatly increase a current of an excitation coil, which increases an engineering difficulty, and increases construction and operation costs at the same time.

Secondly, in the plasma confined by the dipole field, ions with high energy will move to an inner side of an excitation ring along a magnetic field line, and circulate inside and outside the coil. The ions capable of moving to the inner side of the excitation ring have high energy, which is very beneficial for nuclear fusion. The nuclear fusion needs certain vacuum conditions, so that it is necessary to arrange the excitation ring of the dipole field in a vacuum chamber. If the excitation ring of the dipole field in the vacuum chamber is supported by a mechanical structure, the high-energy ions inside the excitation ring will inevitably collide with the mechanical support structure. On one hand, a loss of high-energy ions beneficial for nuclear fusion is caused, thus reducing the fusion efficiency, and on the other hand, the collision will lead to the heating and even melting of the mechanical support structure. Therefore, the excitation ring can only be levitated in the vacuum chamber by an action of a magnetic field force. An externally applied magnetic field for levitating the excitation ring may change the distribution of the dipole field generated by the excitation ring, and although plasma constraint requirements may be met through optimized design, there is still the problem of loss of high-energy ions. In addition, a motion of a normal temperature excitation coil adopting the externally applied magnetic field is unstable, and there is a high requirement for control complexity. Although this problem can be solved by a superconducting excitation ring, there are great problems in the cooling and long-term stable operation of the superconducting excitation ring because there is no external support and connection.

Finally, in order to improve the plasma density, it is also necessary to improve a magnetic field gradient in a plasma confinement region.

### SUMMARY OF THE PRESENT INVENTION

Aiming at the shortcomings of the dipole field fusion device above, this patent provides a magnetic mirror dipole field fusion technology adopting superconductor compression.

A magnetic induction intensity of a dipole field is very low because a magnetic field as shown in FIG. 1 and FIG. 2 is distributed in the whole space. If a current in a coil is determined, a total magnetic flux is determined, and when this limited magnetic flux is distributed in the whole space, it is difficult to improve a magnetic induction intensity at each point in the space, so that in order to improve the magnetic induction intensity, it is necessary to limit the distribution space of the magnetic field, which means to compress the distribution space of the magnetic field.

Relative magnetic permeability of materials in nature is about equal to or much greater than 1 generally. For a material with the relative magnetic permeability about equal to 1, when a magnetic field line passes through an interior of the material, the magnetic induction intensity changes little, so that the magnetic field cannot be compressed by this type of material. For a material with the relative magnetic permeability much greater than 1, when the magnetic field line passes through an interior of the material, the magnetic induction intensity can be improved, so that not only the magnetic field is compressed, but also the magnetic field line attached can be sucked into the material. In this way, the magnetic field may be compressed into the material, but the magnetic field inside the material cannot be used to confine plasma of nuclear fusion.

Only when a magnetic permeability of a material is zero can the magnetic field line be completely excluded from the material, so that the spatial compression of distribution of the magnetic field can be realized by using this material. A superconducting material is the material with zero permeability, so that the superconducting material is used to realize the magnetic field compression of the dipole field in this patent.

The magnetic field generated by the dipole field is shaped as a south pole and a north pole. In the magnetic field as shown in FIG. 1, the north pole is above an excitation ring and the south pole is below the excitation ring. In the dipole field fusion device, many confined plasma are distributed outside the excitation ring, which means to be near an equator of the dipole field, as shown in a gray region outside a coil in FIG. 1. Moreover, the stronger the magnetic field outside the magnetic ring, the higher the gradient of the magnetic field, which is more conducive to the capture and confinement of plasma.

In order to improve the magnetic field outside the magnetic ring, two superconductors for magnetic field compression (abbreviated as magnetic compression superconductors) are arranged near the south pole and the north pole of the dipole field, which can greatly reduce a distribution region of the magnetic field along a rotating shaft, thus improving the distribution of the magnetic field on a plane perpendicular to the rotating shaft and passing through a center of the excitation ring. The magnetic compression superconductors are generally designed symmetrically up and down. No partition is arranged between an outer edge of the magnetic compression superconductor and the rotating shaft, and no through holes leading to magnetic field leakage are arranged (the magnetic field leakage means that if there are the through holes, many magnetic field lines pass through the holes, thus reducing a magnetic induction intensity in a magnetic field compression region). A gap between the magnetic compression superconductor and the excitation ring is small enough, and a magnetic field in the gap can be greatly improved, so that when ions moving along the magnetic line of force enter this gap, the ions are reflected by a strong magnetic field to form a magnetic mirror effect, and this gap region is called a magnetic mirror region. Generally speaking, ions in most plasma rotate around one magnetic field line, and when the magnetic field along the magnetic field line becomes stronger and stronger, and a magnitude of the magnetic field exceeds a certain value, the ions may move in an opposite direction around the magnetic field line and move to a region with a small magnetic field, and a position of the strong magnetic field is called a magnetic mirror. North and south poles of the magnetic field are respectively provided with one magnetic mirror region. When the magnetic mirror region has a sufficiently strong magnetic field, the magnetic mirror region can reflect helium ions generated by fusion, thus easily realizing fusion ignition. A region between two magnetic mirror regions and outside the excitation ring can realize plasma confinement and implement fusion reaction, which is called a fusion region.

Further, the magnetic compression superconductor may be a disc perpendicular to the rotating shaft.

Further, in order to expand an area of the fusion region, a distance between two magnetic compression superconductors can be gradually expanded in a region far away from the rotating shaft.

Further, the excitation ring may be made of a superconducting material, a rotating cross section of the superconducting excitation ring may be a circle, a square and a rectangle, and long sides of the rectangle are parallel to the rotating shaft. The excitation ring with the rectangular cross section may also be called a solenoid or a cylinder. A distance between two magnetic mirror regions formed by the superconducting excitation solenoid and the magnetic compression superconductor is large, and the area of the fusion region formed is large, so that fusion power generated by the device is large.

Further, for the dipole field excitation cylinder, the magnetic compression superconductor may be bowl-shaped.

Because the magnetic field in the magnetic mirror region is very strong, all ions in the fusion region may be reflected, so that the ions cannot pass through the magnetic mirror region from a region outside the excitation ring to reach a region inside the excitation ring, and in this way, the superconducting excitation ring may be mechanical supported and connected, and the superconducting excitation ring may also be cooled at a low temperature by liquid helium input from the outside, thus greatly reducing an engineering difficulty, improving the operation reliability and stability of the device, and solving the shortcomings of current dipole field fusion device.

Further, when a radius of the superconducting excitation ring is increased to be greater than 0.5 m, the fusion region may be located inside the superconducting excitation ring.

### Innovation

The magnetic mirror region of the strong magnetic field is obtained through the magnetic compression superconductor, so that all ions in the fusion region are reflected by the magnetic mirror region, and the ions cannot move back and forth inside and outside the excitation ring, thus easily realizing the mechanical support and cooling engineering of the excitation ring. The dipole field adopting a superconducting magnetic field compressor can obtain a higher magnetic induction intensity, reduce a current of an excitation coil, cancel a levitated coil, and reduce a development difficulty and construction and operation costs.

### DESCRIPTION OF THE DRAWINGS

FIG. 1 is a schematic diagram of a dipole field;

FIG. 2 is a two-dimensional magnetic field distribution diagram of the dipole field;

FIG. 3 is a two-dimensional magnetic field distribution diagram of the dipole field after superconductor magnetic compression in an embodiment of the present invention;

FIG. 4 is a radial one-dimensional magnetic field distribution diagram of superconductor magnetic compression and open space in the embodiment of the present invention;

FIG. 5 is a radial one-dimensional magnetic field exponent distribution diagram of superconductor magnetic compression and open space in the embodiment of the present invention;

FIG. 6 is an axial one-dimensional magnetic field distribution diagram of superconductor magnetic compression and open space in the embodiment of the present invention;

FIG. 7 is a two-dimensional magnetic field distribution diagram of a solenoid dipole field after superconducting disc magnetic compression in the embodiment of the present invention;

FIG. 8 is a two-dimensional magnetic field distribution diagram of the solenoid dipole field after superconducting bowl magnetic compression in the embodiment of the present invention;

FIG. 9 is a two-dimensional magnetic field distribution diagram of the solenoid dipole field fused in a superconducting cylinder in the embodiment of the present invention;

FIG. 10 is an overall structure diagram of the dipole field after superconductor magnetic compression in the embodiment of the present invention;

FIG. 11 is an overall structure diagram of the solenoid dipole field after superconducting disc magnetic compression in the embodiment of the present invention; and

FIG. 12 is an overall structure diagram of the solenoid dipole field after superconducting bowl magnetic compression in the embodiment of the present invention.

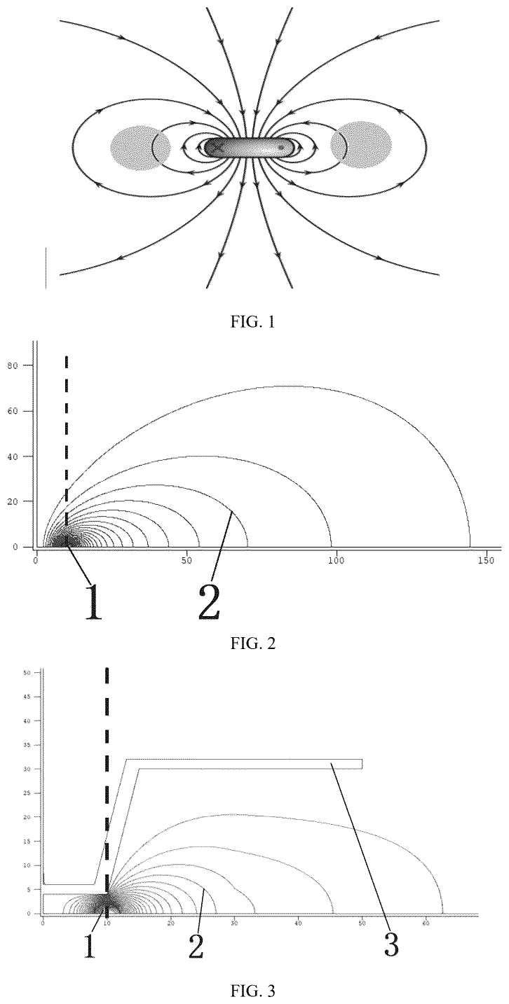

### DETAILED DESCRIPTION OF PREFERRED EMBODIMENTS

To make the objects, technical solutions, and advantages of the present invention clearer, the present invention is further described in detail hereinafter with reference to the drawings and embodiments. It should be understood that the specific embodiments described herein are only used for explaining the present invention, and are not intended to limit the present invention.

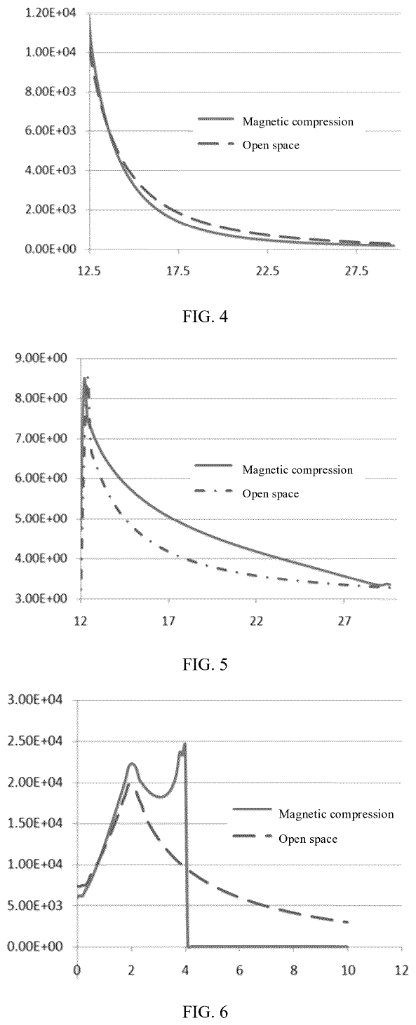

Magnetic field distribution of a dipole field is as shown in FIG. 2, only a part of the whole dipole field is shown in the figure, and the whole part needs to be shown by making FIG. 2 symmetric along an X axis and then rotationally symmetric along a Y axis. Reference numeral 1 refers to an excitation ring of the dipole field, and reference numeral 2 refers to a magnetic field line of the dipole field. Magnetic field distribution along the X-axis in FIG. 2, which is a radial direction of the dipole field, is as shown by a dotted line of an “open space” in FIG. 4.

### Embodiment 1

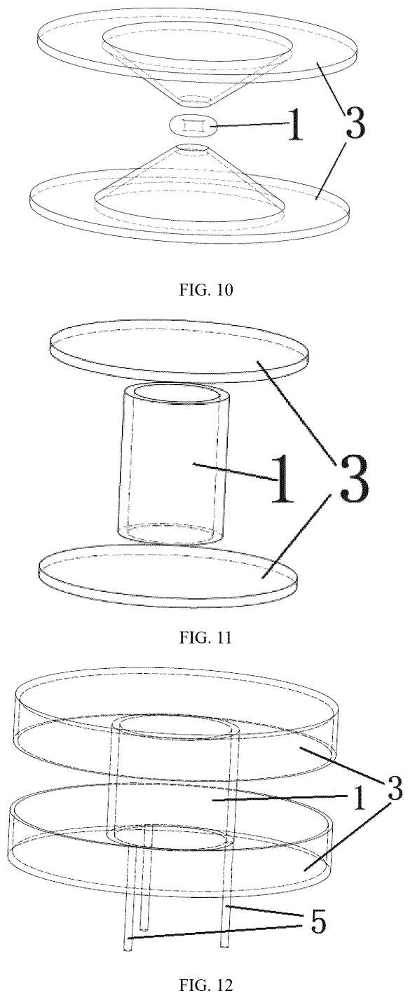

A magnetic mirror dipole field technology provided by the present invention is based on FIG. 2, two magnetic compression superconductors 3 are added above and below an excitation ring 1 respectively, and an overall structure is as shown in FIG. 10. Because the superconductors 3 have a repulsive interaction with a magnetic field, a magnetic field line will not enter the superconductors, and a magnetic field distributed along a Y direction (which is an axial direction) may be compressed, thus forming magnetic field distribution as shown in FIG. 3. A gap between the excitation ring 1 and the superconductor 3 is a magnetic mirror region. A region outside the excitation ring 1 is a fusion region. In order to enlarge the fusion region, a distance between two superconductors 3 in the axial direction is increased rapidly with an increase of a radius outside the magnetic mirror region. After a sufficient gap is expanded, the distance is no longer increased, and the distribution of the magnetic field along the radius is decreased faster than that of an open space, as shown in FIG. 4. A magnetic field gradient is as shown in FIG. 5, and the magnetic field gradient obtained by magnetic field compression of the superconductor 3 in the fusion region outside a coil is larger than that in the open space. The increase of the magnetic field gradient is beneficial for plasma confinement in the fusion region. The magnetic field distribution on a straight line(shown as the dash line in FIG. 2 and FIG. 3) parallel to a rotating axis and passing through a center of a rotating cross section of the excitation ring 1 is as shown in FIG. 6. A position where an abscissa value is equal to 2 is the radius of the excitation ring 1, which shows that the magnetic field in the open space is decreased gradually in the axial direction; and a position where the abscissa value is equal to 4 is a position of the magnetically confined superconductor 3, which shows that the magnetic field in the gap between the excitation ring 1 and the superconductor 3 is greatly improved, thus forming the magnetic mirror region.

### Embodiment 2

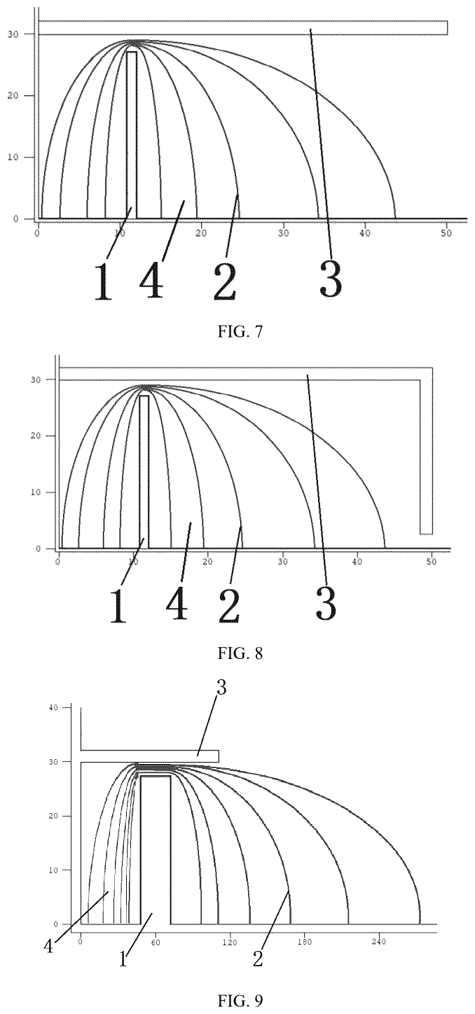

An excitation ring 1 is made of a superconducting material, and a rotating cross section of the excitation ring 1 is a rectangle. Long sides of the rectangle are parallel to a rotating shaft, which means that the excitation ring 1 is a cylinder, and a length of the cylinder is greater than 0.5 m. An overall structure is as shown in FIG. 11. A magnetic compression superconductor 3 is disc-shaped, and a radius of the disc is greater than a gyration radius of the superconducting excitation cylinder, thus forming magnetic field distribution as shown in FIG. 7. A distance between two magnetic mirror regions formed in this way may be very large, which is beneficial for plasma confinement of and fusion region expansion. Reference numeral 4 refers to a fusion region.

### Embodiment 3

In order to further improve a magnetic induction intensity and a magnetic field gradient in a fusion region, a superconducting plate in FIG. 7 may be changed into a bowl-shaped superconductor, as shown in FIG. 8. An overall structure is as shown in FIG. 12. The mechanical support for the excitation cylinder is also shown as the reference numeral 5.

### Embodiment 4

When an inner radius of an excitation cylinder 1 is increased to, for example, above 0.5 m, a sufficiently large space is formed inside the excitation cylinder 1, and this space may be used as a fusion region, as shown in a region indicated by reference numeral 4 in FIG. 9.

FIG. 10, FIG. 11 and FIG. 12 only show a main functional structure of a magnetic compression dipole field fusion device, and other auxiliary structures of the device are not shown in the figures, such as a vacuum chamber, a vacuum pump and a cooling system.

After considering the specification and practicing the invention disclosed herein, those skilled in the art may easily think of other embodiments of the present invention. The present application is intended to cover any variations, uses, or adaptive changes of the present invention. These variations, uses, or adaptive changes follow the general principles of the present invention and comprise common general knowledge or common technical means in the art, which are not disclosed in the present invention. Therefore, if these variations, uses and adaptive changes of the present invention fall within the scope of the claims of the present invention and their equivalents, the present invention is also intended to comprise these variations, uses and adaptive changes.

The above embodiments are only illustrative descriptions of the present invention, and the present invention can also be implemented in other specific ways or other specific forms without deviating from the main idea or essential characteristics of the present invention. Therefore, the described embodiments should be considered as being illustrative rather than restrictive in all aspects. The scope of the present invention should be described by the appended claims, and any changes equivalent to the intent and scope of the claims should also be included in the scope of the present invention.

We claim:

1. A magnetic mirror dipole field fusion device, comprising an excitation ring and two magnetic compression superconductors, wherein the excitation ring generates a dipole magnetic field; and two magnetic compression superconductors are provided and respectively located near a south pole and a north pole of the dipole field, so that a distribution space of the dipole magnetic field in an axial direction is reduced, a magnetic induction intensity of a magnetic field in a fusion region is improved, and a magnetic mirror region is formed in a gap between the excitation ring and the magnetic compression superconductor.

2. The magnetic mirror dipole field fusion device according to claim 1, wherein the excitation ring is symmetrical about a rotating shaft, and a cross section of the excitation ring is a circle, a square and a rectangle; and long sides of the rectangle are parallel to the rotating shaft.

3. The magnetic mirror dipole field fusion device according to claim 1, wherein the excitation ring is an excitation ring made of a normal temperature material.

4. The magnetic mirror dipole field fusion device according to claim 1, wherein the excitation ring is an excitation ring made of a superconducting material.

5. The magnetic mirror dipole field fusion device according to claim 1, wherein a rotating shaft of the magnetic compression superconductor is coaxial with the rotating shaft of the excitation ring; the magnetic compression superconductors are designed symmetrically up and down; and no partition is arranged between an outer edge of the magnetic compression superconductor and the rotating shaft, and no through holes leading to magnetic field leakage are arranged.

6. The magnetic mirror dipole field fusion device according to claim 5, wherein an axial distance between the upper and lower magnetic compression superconductors is the smallest in the magnetic mirror region, the axial distance is increased rapidly with an increase of a radius outside the magnetic mirror region, and the axial distance is no longer increased after a sufficient gap is expanded.

7. The magnetic mirror dipole field fusion device according to claim 1, wherein the excitation ring is a superconducting excitation cylinder, and a length of the excitation cylinder is greater than 0.5 m; the magnetic compression superconductor is a disc, and a radius of the disc is greater than a gyration radius of the superconducting excitation cylinder; when an inner radius of the excitation cylinder is less than 0.5 m, the fusion region is outside the excitation cylinder; and
when the inner radius of the excitation cylinder is greater than 0.5 m, the fusion region is inside the excitation cylinder.

8. The magnetic mirror dipole field fusion device according to claim 1, wherein the magnetic compression superconductors are bowl-shaped and symmetrical up and down.

9. The magnetic mirror dipole field fusion device according to claim 1, wherein the excitation ring is mechanically supported, and the excitation ring is cooled by external introduction of a coolant.
